(19) United States
(12) Patent Application Publication
(10) Pub. No.: US 2004/0181813 A1
(43) Pub. Date: Sep. 16, 2004

(54) Methods and systems for rapid channel change within a digital system

(76) Inventors: Takaaki Ota, San Diego, CA (US); Priyan Deveka Gunatilake, San Diego, CA (US); Christopher Jensen Read, San Diego, CA (US)

Correspondence Address: WAGNER, MURABITO & HAO LLP, Third Floor, Two North Market Street, San Jose, CA, 95113, US

(21) Appl. No.: 10/806,615

(22) Filed: Mar. 22, 2004

Related U.S. Application Data
(63) Continuation-in-part of application No. 10/366,781, filed on Feb. 13, 2003.

(51) Int. Cl. H04N 7/173; H04N 7/16; H04N 7/10; H04N 7/025

(52) U.S. Cl. 725/131; 725/139; 348/564; 348/565; 348/731

(57) ABSTRACT

Methods for providing fast channel change in a digital display system. Spare tuners can be provided for predicting a next channel that may be viewed. These spare tuners may be used to capture information that is used to provide a fast channel change to an accurately predicted next channel. A spare tuner may be a PIP tuner. A three tuner system can be used where multiple tuners are applied to multiple predicted channels. Also, a spare tuner can be used to scan available channels and cache information on a set of channels to provide a fast channel change to a cached channel. The information cached can include program information, e.g., table information. Spare decoders (e.g., virtual decoder) can also be used to predict a next channel and provide fast channel change thereto.

### RELATED U.S. PATENT APPLICATION

This application is a Continuation-in-Part to, and claims priority from, the following commonly-owned co-pending U.S. patent application Ser. No. 10/366,781, entitled “METHOD AND SYSTEM FOR RAPID CHANNEL CHANGE WITHIN A TRANSPORT STREAM,” filed Feb. 13, 2003, attorney docket number SONY-50R4614, and assigned to the assignee of the present invention. The referenced U.S. patent application is hereby incorporated by reference in its entirety.

### FIELD OF THE INVENTION

Embodiments of the present invention relate to the field of digital television devices and the like.

### BACKGROUND OF THE INVENTION

Digital television delivers a variety of information and entertainment to viewers. An immense amount of very high quality digital video is available via broadcast, cable, and direct satellite communication.

A feature of digital television broadcast and cable delivery is the necessity of compressing a high-quality video image into a narrow bandwidth for storage and transport as an encoded and multiplexed signal. Compression and multiplexing allow for a single transport stream, carrying many channels, or programs, of digital television programming, to fit in the limited RF bandwidth of a legally defined frequency in the public airwaves. Encoding also allows the bandwidth necessary to efficiently use a cable to carry many different digital transport streams.

The common television formats used throughout the world involve presenting a sequence of picture frames in a display. Each of the frames, when compressed, must still be able to recover the visual information that is necessary to show the full, uncompressed, frame when presented in the ultimate display. The digital television standards in use allow for multiple compressed video programs with compressed audio as well as data channels.

It is noted here that the use of MPEG in this context refers to the various compatible compression standards of the Motion Picture Experts Group which has promulgated several standards relating to compressed digital data delivery systems. One, known as MPEG-1, refers to ISO/IEC standards 11172 and is incorporated herein by reference as background. A second, known as MPEG-2, refers to ISO/IEC standards 13818 and is incorporated herein by reference as background. The delivery of coded video is commonly accomplished under ATSC (Advanced Television Standards Committee). A compressed digital video system is described in the ATSC digital television standard document A/53, also incorporated herein by reference as background.

A common video compression, or encoding, method is MPEG-2 which employs three different types of frames. The Intra-frame, or I-frame, incorporates all the information necessary to be decoded by itself. The other types of frames have to depend on an I-frame at some point. An I-frame provides the least amount of compression when encoded. The predictive frame, or P-frame, uses motion-adjusted differences from a previous reference frame to avoid redundant coding. The P-frame allows a greater amount of compression than the I-frame. The bi-directional frame, or B-frame, uses motion adjusted differences from both a previous and a future frame. The B-frame allows the greatest amount of compression when encoded.

It is noted that referencing incomplete frames to complete frames for decoding and decompression is not limited to MPEG compression schemes. Other encoding and compression techniques also use such referencing.

The three types of frames may all be incorporated when a program is encoded under MPEG. When more than one program is multiplexed into a single transport stream, the coded packets that contain the transported fragments of the encoded frames, in most coding conventions, are interleaved with each other. A demultiplexer at a receiving device can separate out the programs and, when a particular program is desired, decode the program for presentation in a display. A transmitted table, commonly called a program association table, is used to aid the multiplexer in separating the digital packets of a transport stream.

Conventional art FIG. 1A illustrates an exemplary system that transports, receives and presents digital television from either broadcast or digital cable. It is noted that the illustrated system is only representative of digital television reception and does not show the workings of any specific device or system. Transport stream 100, containing the information necessary to present more than one channel of television viewing, including audio and data, is demultiplexed at 101. A channel desired by the user, is selected and decoded at 102. The result of this decoding is program 104 which is presented to display 106.

In the exemplary system illustrated in FIG. 1A, a second displayed channel is available in picture-in-picture display 107. The program content 105 is provided by decoder 103 from another demultiplexed program stream. This encoded program channel is also provided by tuner/demultiplexer 101.

In conventional art FIG. 1B, the coded frames component of a transport stream is illustrated. A typical transport stream, such as shown at 120, contains, among other channels of information, channels of data packets which encode the frames of video sources. As noted above, multiple channels may be encoded and multiplexed in a single digital transport stream. The time-equivalent frame sequence of more than one encoded and multiplexed channel is what is illustrated in FIG. 1B. Exemplary I-frame 121 is shown as an I-frame from one channel, channel A, as an example. Exemplary P-frame 122 is shown as a P-frame of channel A and exemplary P-frame 123 is shown as a B-frame of channel B. Exemplary I-frame 124 is an I-frame of channel B and P-frames 125 and 126 are exemplary P-frames of channels A and C, respectively. The other exemplary frames are P- and B-frames of other channels.

It is noted that the exemplary frames are shown in different sizes. P-frames are shown larger than B-frames and I-frames are shown as the largest. The difference in size is only for the sake of illustration of the relative compression ratios of the frames. An I-frame offers the least compression and a B-frame offers the most.

It is also important to note that video information is not coded into a transport stream as frames but as coded data packets which represent the frames and that packets containing data from frames of different programs may be interleaved together. FIG. 1C illustrates data packets which contain the information from which frames are constructed upon decoding. Exemplary transport stream 131, comprising frame-encoded MPEG format content, is packetized at 132 into transmittable packets 133. Each packet 133 is characterized by a fixed maximum size and is appended with a packet header which contains data that identifies the packet, the packet identifier or PID, as well as the channel associated with the packet. The packets illustrated are shown as parts of two different program channels, x and y. Thus the packet identifiers are indicated as PIDx and PIDy.

The table in which the program information is presented is a program association table. It is noted that, in this packetization, a packetized digital transport stream 134 is formed from an MPEG-encoded video source.

It is noted that some packets are required to carry non-program content. Some of this data is associated with program content, such as program specific information (PSI). Some of the functions of PSI are delineated in ISO/IEC standards 11172 and 13818, referenced above. The illustrations of FIGS. 1A, 1B and 1C are shown to illuminate the background of digital television transmission.

It is further noted here that there is not a specific order to frames or to channels when several are multiplexed into a single transport stream. The adaptive compression rate of MPEG-2 means that different parts of different programs compress more or fewer frames into a given amount of available bandwidth, depending on the instant video content. For this reason, there can be as much as several seconds between receiving of sequential I-frames of any particular channel. Because of the possible wait time for a first received I-frame after a channel switch by a user, and its subsequent decoding, a channel change causes a temporary delay before the new channel image can be displayed. Alternatively, some displays may present a brief amount of artifacts or other unwanted images as a result of incomplete decoding as a result of the channel switch.

This is because, in a single program video bit stream, an I-frame is inserted between groups of P- and B-frames. In a multiplexed transport stream, there may four to six, or more, programs multiplexed together. The next I-frame after a switch to a desired channel could lag two or more seconds behind the channel switch.

Some of the desirable features of analog television have not easily made the transition to digital format. Among these is the ability to rapidly switch channels. Another desirable feature, found in higher quality analog televisions, is “picture-in-picture” or PiP. PiP-equipped television allows a viewer to watch one program, or channel, in the main or full-size display and another program in a smaller frame within the display. A common usage of the PiP system is to preview another program for a possible channel switch.

Television viewers perceive seamless, rapid switching from one channel to another to be an important television receiver characteristic. The necessity of referencing an I-frame when decoding digital television can make channel switching time long when compared to the switching times of traditional or analog television receivers. Thus, in some cases the viewer can be presented with a blank or otherwise non-program screen for several seconds when switching channels in a digital television coupled to the digital transport stream.

The lack of a fast channel change can be detrimental to the digital television viewing experience because each channel may require as much as one to two seconds for display.

### SUMMARY OF THE INVENTION

Accordingly, an embodiment of the present invention is directed to novel methods and systems for enabling a rapid channel change in a digital transport stream that contains a number of channels by storing recent information for channels, e.g., by predicting next channels or scanning sets of channels.

SPARE TUNERS/DECODERS: In one embodiment, a spare tuner, or a dedicated extra tuner, can be employed to cache digital content from a predicted next channel while another channel is being rendered in the main display area of a display device. If that predicted channel is in fact next selected for viewing, then the spare tuner can be used to display that next channel in the main display according to a fast channel change technique. The spare tuner can be a picture-in-picture tuner, in one embodiment.

More specifically, this embodiment of the present invention relates to a method for displaying digital content in a fast channel change mode that use a first tuner to access a first transport stream associated with a first frequency and displaying a program associated with the first transport stream in a main picture area of a display screen and using a second spare tuner/decoder to tune a predicted next channel, or to scan through a set of channels in round-robin fashion, and cache information. The second tuner/decoder may be normally dedicated to rendering a picture-in-picture on the display screen or may be a dedicated spare tuner. In this embodiment, upon the first tuner being switched to a new channel associated with the digital contents stored in the memory buffer (e.g., cache), the system recalls the cached information for use in providing a fast channel change operation to the new channel. A spare third tuner/decoder can also be used for predicting and caching information on more channels. Upon a channel change to an accurately predicted next channel, tuner roles can swap. A switched universal system having M tuners and N decoders is also described.

SPARE TUNER SCANNING TABLE INFORMATION: In another embodiment of the present invention, the system makes use of an “unused” or spare tuner/decoder in the system in a scanning mode. In this use, the tuner/decoder caches information from a program association table in the transport stream. Decoding of a transport stream requires the table information. The table information describes how many programs there are in the transport stream, which program identifiers (PIDs) identify the audio and video components of the programs, when the programs start/stop, what the program titles are, etc. Transport stream table information is transmitted at a frequency on the order of seconds, so caching the information can be very beneficial. In another embodiment, the receiving system, even when “off”, can scan through the channels to cache the channel tables. This can be accomplished with a receiver implemented with one tuner/decoder. The spare tuner may be the PIP tuner that can be used in this fashion during spare periods.

USE OF VIRTUAL DECODERS: In another embodiment, an additional complete MPEG decoder can be available to be used to prepare a predicted next program channel to be decoded and ready to display upon selection for fast channel change. In the case where the predicted next program is in the same transport stream as the program currently being decoded, the “unused” MPEG decoder can also demultiplex the transport stream and decode the predicted next selected program. In the case where the predicted next selected program is carried in a different RF carrier frequency, the unused tuner/demodulator can tune to the frequency for the predicted program channel and decode the predicted program.

By employing an additional MPEG decoder, the speed with which an individual channel change can occur is increased, since the new program to be switched to can be completely decoded and ready to display. In this case the channel change can truly be instantaneous. A frame from the new program can begin as soon as the request is received to switch to that channel.

As disclosed above, embodiments of the present invention are also enabled to provide rapid channel change in a digital picture-in-picture television. Multiple decoders are used in these embodiments to pre-decode and store program specific information for predicted channels.

These and other objects and advantages of the present invention will become obvious to those of ordinary skill in the art after having read the following detailed description of the preferred embodiments which are illustrated in the various drawing figures.

### BRIEF DESCRIPTION OF THE DRAWINGS

The operation and components of this invention can be best visualized by reference to the drawings.

FIG. 1A (Conventional art) illustrates exemplary digital television transport stream reception.

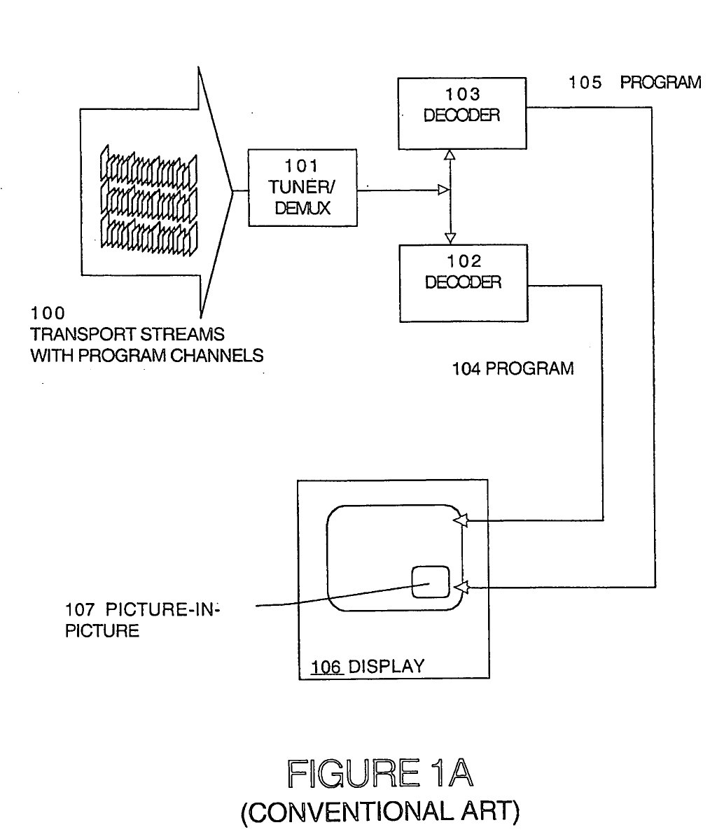

FIG. 1B (Conventional art) illustrates exemplary digital television transport stream encoding.

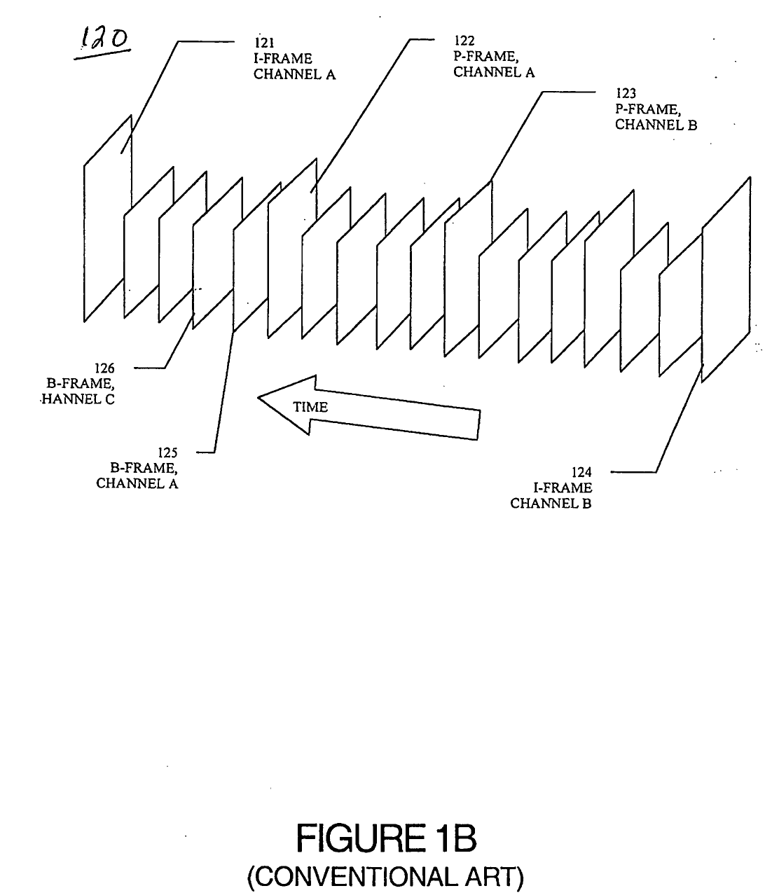

FIG. 1C (Conventional art) illustrates exemplary digital television transport stream packetization.

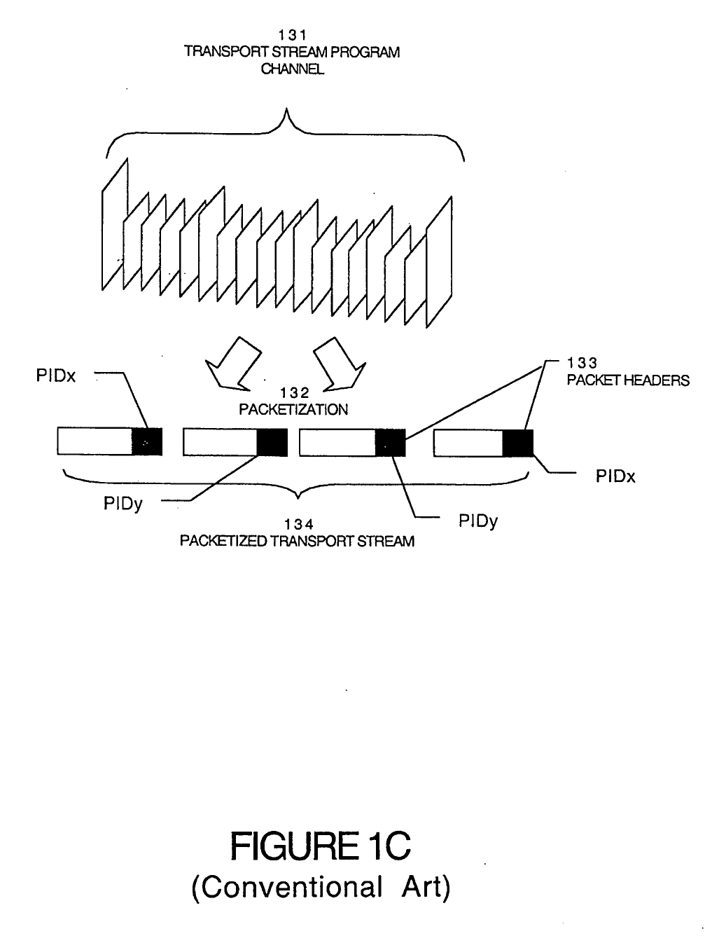

FIG. 2A illustrates a method for rapid digital television channel change between RF frequencies in a picture-in-picture receiver in which a second tuner and second decoder (e.g., PIP tuner) are used to scan channels and cache table information for potential next channels.

FIG. 2B illustrates a system for rapid digital television channel change between RF frequencies in a picture-in-picture receiver in which a second tuner and second decoder are used to cache information for a set of potential next channels.

FIG. 3A illustrates a method for rapid digital television channel change using one or more spare tuner(s) caching digital content of one or more predicted next channel(s) in accordance with an embodiment of the present invention.

FIG. 3B illustrates a system for rapid digital television channel change in a picture-in-picture receiver in which a plurality of tuners and decoders are used to scan and decode a plurality of transport streams in order to cache digital content of one or more predicted next channels in accordance with an embodiment of the present invention.

FIG. 3C illustrates a system for rapid channel change in a PIP receiver in which a second tuner and decoder are used to scan and decode a plurality of transport streams in order to cache multiple digital content for predicting a next channel in accordance with an embodiment of the present invention.

FIG. 4 illustrates a universal switched system for rapid digital television channel change in which a crossbar switch is used to connect each of a plurality of M tuners to any of a plurality of N decoders in accordance with an embodiment of the present invention.

FIG. 5A illustrates a method for rapid digital television channel change using a second “spare” decoder to predictively decode a program channel in accordance with an embodiment of the present invention.

FIG. 5B illustrates a system for rapid digital television channel change using a second “spare” decoder to predictively decode a program channel in accordance with an embodiment of the present invention.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description, numerous specific details are set forth in order to provide a thorough understanding of the present invention. However, it should be understood by one of ordinary skill in the art that the present invention may be practiced without these specific details. In other instances, well-known methods, procedures, components, and circuits have not been described in detail so as not to unnecessarily obscure aspects of the present invention. At times, concepts disclosed in this discussion of embodiments of the present invention will be made more readily apparent by reference to the Figures.

Embodiments of the present invention provide for rapid, seamless, changing of channels that can be employed at the receiver of a digital television transport stream. It is noted that, as used herein, “rapid” and/or “seamless” implies an apparently instantaneous channel change, where there is no noticeable non-program screen displayed to the viewer, e.g., in a manner similar to the channel change experience of analog television.

It is noted, too, that the ensuing use of the terms “tuner”, “decoder”, “demodulator” or demultiplexer” is not meant to imply any specific hardware configuration or device. The terms are meant to impart a functional environment for the implementation of embodiments of the present invention. The terms can be used, for example, to indicate a collection of functional devices whose functions can comprise demodulating a broadcast carrier or a dedicated cable carrier, demultiplexing a transport stream to separate a plurality of program channels, decode a packetized digital transport stream to acquire packet-encoded program content, or to decode program content into displayable video frames, audio or other data. The terms may be used herein to be read as implying function rather than form.

### Fast Channel Change Using Spare Tuner/Demodulator for Scanning and Caching Table Information

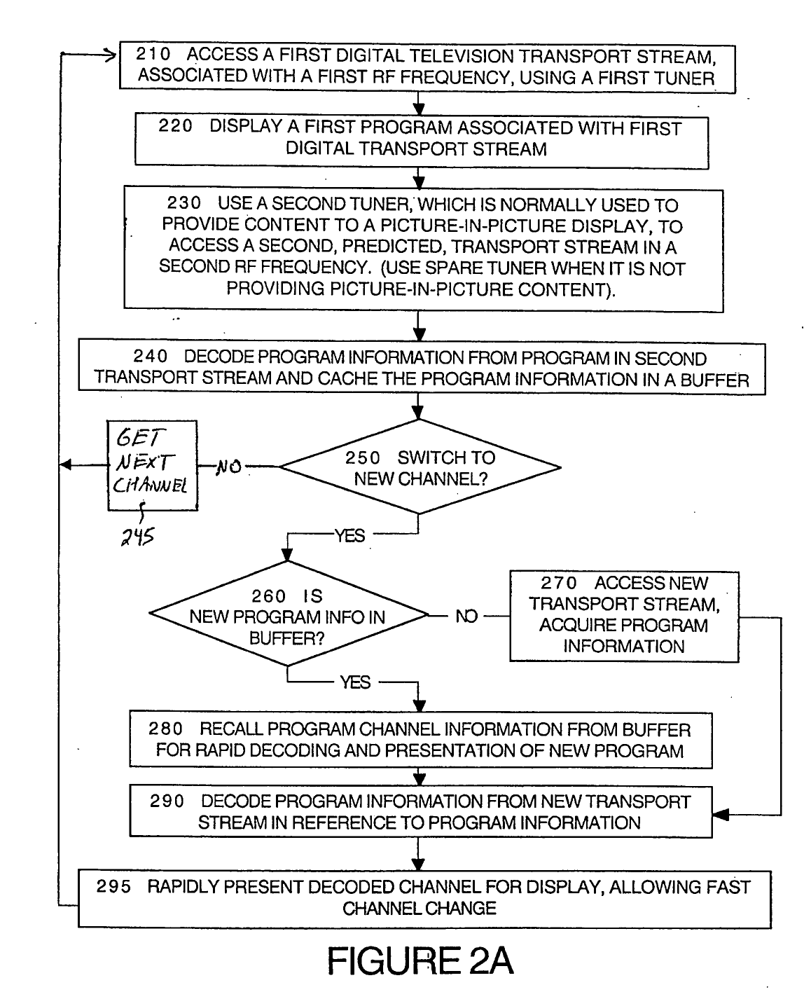

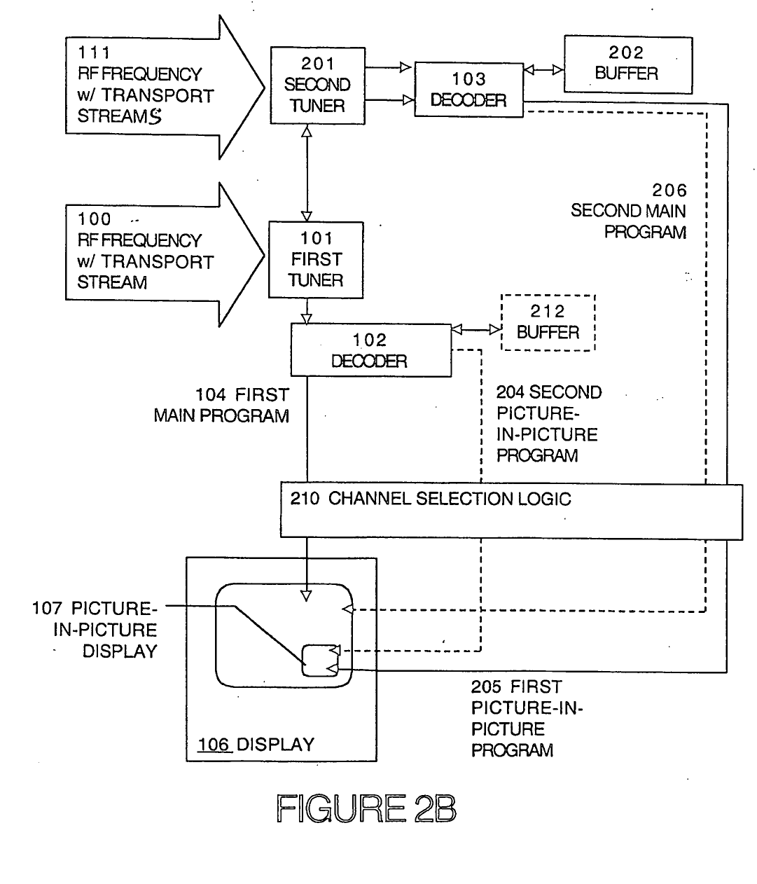

It is noted that, in broadcast or digital cable TV implementations, there are commonly a plurality of different programs contained within a single digital transport stream. One component of fast channel switching, according to FIGS. 2A and 2B, provides switching between different channels with little or no perceptible delay in presenting the new channel by caching the new channel's program information (e.g., table information).

Transport streams, it is also noted, can be carried in different RF frequencies or multiplexed in the same frequency or they can also be multiplexed together in a single cable pathway. Embodiments of the present invention are enabled to provide rapid, seamless, channel change between program channels carried in different transport streams as well as between channels carried in the same transport stream.

Before a change to a new channel can take effect and the new channel displayed, program table information and an I-frame, in the case of video program content, are decoded in the new program. Program table information is required for proper multiplexing of the data packets of the transport stream and is therefore required for decoding an I-frame if a particular channel.

As described below, table information allows the sorting of digital packets of a transport stream to their associated programs (e.g., data, audio, visual). It is noted that a transport stream can comprise a mix of multiple program channels where each program channel consists of a video stream and one or more audio and data streams. Each program channel is associated with program specific information (PSI) such as a program identifier (PID) and other information in the program association table. Generally, a transport stream comprises a sequence of digital packets which are often of fixed length and share a common structure.

Each digital packet further has a packet identifier field in the header which may be an integer number that identifies what the payload of the packet carries and is used to determine the channel to which the packet belongs and whether it is an audio channel, video channel or data channel, for instance. In a receiver, a demultiplexer looks up the PID of a packet and routes it to an appropriate processing unit, such as video decoders and audio decoders. This means that the system needs to know the correct PID number that is assigned for each service. This PID number-to-service relationship is described in one or more digital tables of program association information (e.g., “table information”) and are transmitted as “in-band” information, meaning that the tables are also carried by some of the packets in the packet stream. Therefore, a few PID numbers are reserved for special purposes such as carrying this table information.

Because the point at which a receiver starts reception of a particular transport stream can be a random event, it is desirable to have table information transmitted as frequently as possible. However, for the sake of transmission efficiency, the table information is transmitted usually at a few hundred milliseconds in interval. Because of this mechanism, there may be an inevitable delay between when a receiver starts receiving a new transport stream and when the desired packets start to be routed to the appropriate decoders and when the decoder starts to decode the program content. Embodiments of the present invention are directed to caching certain program specific information to reduce this delay when switching between transport streams to provide seamless channel change across different transport streams.

Accordingly, FIG. 2A illustrates, in flow diagram form, a process for implementing a rapid and seamless channel change within a digital television transport stream according to one embodiment that utilizes a spare tuner for scanning and caching program information, e.g., table information. In this embodiment of the present invention, a second or spare tuner can be used to scan channels in available digital transport streams. This scanning can be done to acquire program information for the transport streams of the scanned channels. Each set of program information is then stored in a buffer and is ready to be used when its associated channel is selected for presentation.

A “spare tuner” can be a dedicated spare tuner, or can be a tuner dedicated to other functions but used in this scanning/caching capacity during spare periods, e.g., spare when not employed to provide picture-in-picture program content. This embodiment is discussed further in relation to subsequent illustrations.

Process 200 starts, at step 210, with a first tuner accessing a digital television transport stream, that contains one or more digital television program channels including a first channel. It is noted again that the term “tuner” is used to denote any means of selecting a specific transport stream from a stream carrying medium such as an RF frequency. The term is also occasionally used herein to denote a means of demultiplexing a specific program channel from a cable or other non-RF source medium, and tuner and demultiplexer are sometimes used interchangeably. Generally, however, the term “tuner” indicates a device by which a program channel is accessed.

The first channel is displayed in a main display area at step 220 by using of a first decoder. The display of step 220 is accomplished by use of decoding of the program and displaying in a system which can include, in this embodiment, any suitable display device such as a video monitor for a video data, an audio output system for audio data, and any suitable presentation or use for related data, such as decoding keys or program identifiers.

At step 230, scanning commences using a second tuner. That is, a second tuner is used to scan through a set of channels, e.g., the scan set to cache information thereof. To start the scanning process, the second tuner accesses a second program channel. The second tuner may be spare and, in one embodiment, it may be the tuner that is normally used to provide video and audio to a second display whose video is presented in a frame within a larger video display, simultaneously with the program presented in the main display frame. A receiver enabled to provide such a display, whether analog or digital, can be called a “picture-in-picture” display. Alternatively, the spare tuner may be a dedicated spare tuner for performing the scanning/caching functions described herein.

At step 240, the program information (e.g., table information) associated with the transport stream of the second program channel is cached in a buffer. Program information, in this usage, is meant to indicate information that enables the demultiplexing of a program channel from its associated transport stream and that enables its decoding for presentation. As described above, program information is typically transmitted in packets in a transport stream in a program association table and can include such information as program identifiers (PIDs).

At 250 of FIG. 2A, if the user selects a new channel, then step 260 is entered. Otherwise, at step 245, a next channel of the scan set is selected and steps 230 and 240 are performed for that next channel, e.g., the program information (e.g., table information) for the transport stream associated with the next scanned channel is cached. The channel scanning occurs in round-robin fashion to cache the table information for each of the channels of the scan set. While this is happening using the second tuner, the first channel continues to be displayed using the first tuner.

At 250, if a new or next channel is selected by the user, then 260 is entered to check if the next channel is among the scan set of channels. If so, then 280 is entered. The new program channel's program information is recalled from the buffer at step 280 of FIG. 2A and is used to enable the decoder to immediately begin decoding the selected channel for viewing on the main display. This immediate decoding of the program enhances rapid channel change to the new channel in the main display area.

More specifically, at 290, the selected program channel is decoded by reference to the program information and, at 295, is presented for display in the main display area. It is noted here that “display” is used herein to denote both visual display of video programming content and also the aural presentation of audio programming content. A video display can be, for example, a television screen or a monitor. The use of other data, for example a network program guide in digital format, can also be presented to either a visual or other device when the program channel is displayed.

If, at 260, the newly selected channel does not have its program information stored in a buffer, the program information is retrieved by accessing the program channel at 270. When the program information is acquired, decoding of the program content commences as outlined above, at step 290.

It is further noted that, in an embodiment of the present invention, the program information that can be cached in buffers can also include an I-frame from an MPEG-encoded video program. Caching an I-frame in addition to program information further enhances the speed of program channel changes.

FIG. 2B illustrates a system for rapid digital television channel change between RF frequencies in a picture-in-picture receiver in which a second tuner (“spare tuner”) and second decoder are used to scan a set of channels for caching their relevant table information in accordance with an embodiment of the present invention.

In FIG. 2B, RF frequencies 100 and 111 carry digital television transport streams. The frequencies are tuned by tuners 101 and 201, respectively. It is noted that, though the RF spectrum is illustrated as the carrying medium for transport streams, digital transport streams can also be carried in other media, such as cable, fiber-optic line, digital satellite communication or can be supplied from a source such as a DVD player or VCR. In each embodiment, digital transport streams are accessed and are decoded for presentation.

In the operation illustrated in FIG. 2B, first tuner 101 is tuned to RF frequency 100 and supplies a transport stream to decoder 102. Not shown in this illustration is a demultiplexer which can be part of either the tuner or the decoder, or can be a stand alone device. A demultiplexer can separate out a single program channel. One implementation of a demultiplexer can be, in one embodiment, a PID filter which allows passage of only those transport stream data packets whose headers contain a specific program identifier, thus passing only one program channel. The second tuner 201 is coupled to tune a plurality of different transport streams 111.

It is also noted that the first decoder and the second decoder, illustrated at 102 and 103, respectively, may be coupled to a common tuning device if the first and second channels are from the same tuned RF frequency of the transport stream. An additional tuner is required if two or more RF frequencies are involved in supplying digital transport streams to the receiver.

Decoder 102 receives the first encoded program channel stream and decodes the stream in to its presentable parts 104 which can be video, audio or data to be delivered to the main display area of display 106. It is noted that the audio and video portions of program content are typically encoded under the MPEG-2 standard.

Decoder 103 receives the encoded second transport stream from spare tuner 201, in this embodiment. Decoder 103 decodes the encoded program content and normally forwards the decoded content 205 to picture-in-picture display 107. In one embodiment, when decoder 103 is not being tasked to decode the encoded program stream in this embodiment, it caches program information of a next channel being scanned in buffer 202 for subsequent use in decoding the stream. As discussed above, channels of a scan set are scanned in round-robin fashion by tuner 201 and an array of table information regarding their transport streams may be cached in buffer 202 and thereby updated periodically.

Buffer 202, in one embodiment, may be implemented with the capability of storing multiple sets of program information through channel scanning of the spare tuner. With this implementation, the likelihood that the selected channel's information is available for use in program decoding is increased, thus enhancing rapid channel change.

Channel selection logic 210 is shown to illustrate the function of changing channels in one embodiment. One implementation of channel selection logic can be of any suitable means by which channels are changed within a digital television receiver.

In a situation in which the user wishes to select the program currently being viewed in the picture-in-picture display 107 as the primary program, a simple switching of programs, accomplished by means indicated by channel selection logic 210, swaps the roles of the tuner/decoder combinations and the PiP program instantly becomes the primary program. If no program is currently being viewed in the PiP display 107, decoder 103 is tasked to commence decoding the new channel in reference to program information stored in buffer 202 and to deliver the program stream 206 to the display.

In one embodiment, selection of the program channel currently being viewed in the picture-in-picture display 107 may result in the swapping of roles of the two decoders. Decoder 103 commences supplying its decoded program stream 206 to the main display 106. Decoder 102 is then free to either supply the PiP program stream or to decode other program channels' program information for caching in buffer 212 or for presenting PiP program stream 204 to the picture-in-picture display 107.

### Fast Channel Change Using Multiple Tuners/Decoders

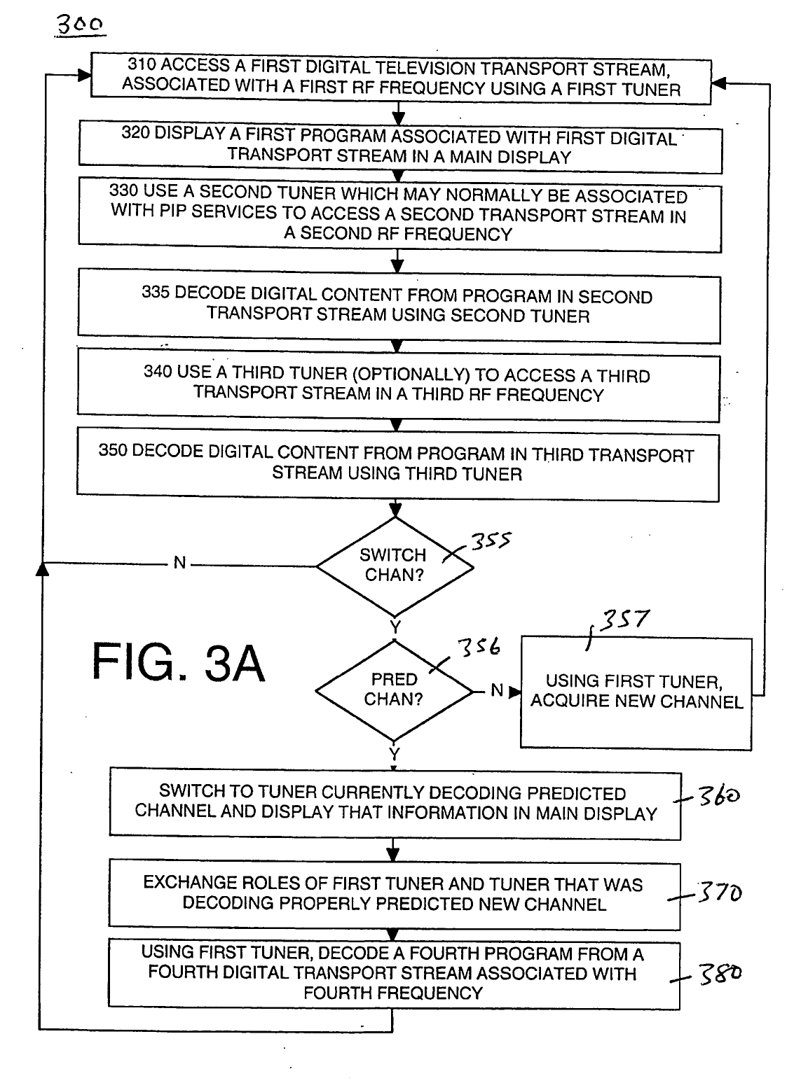

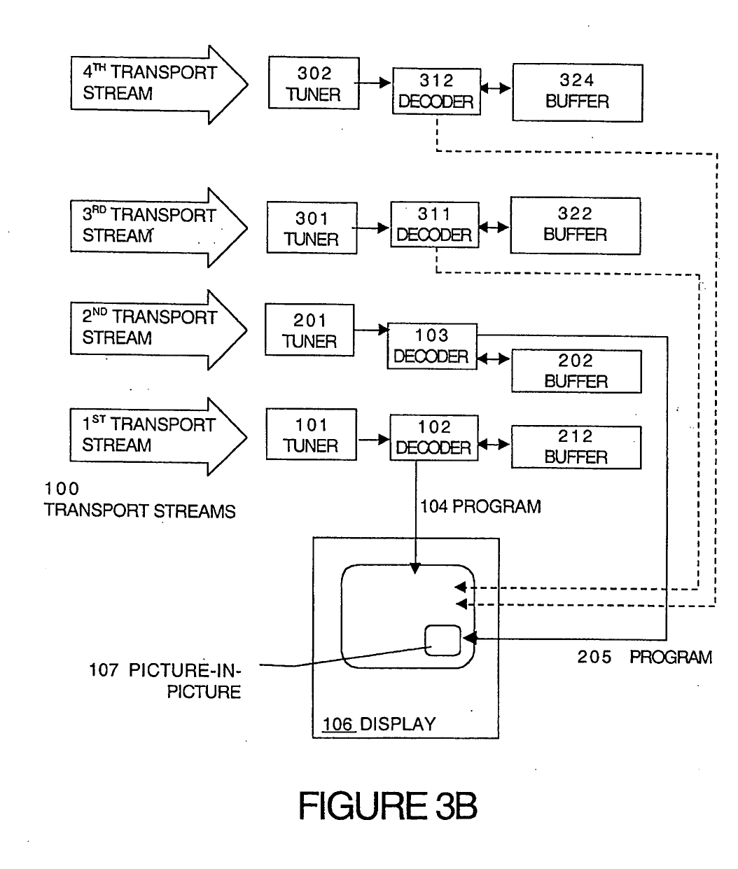

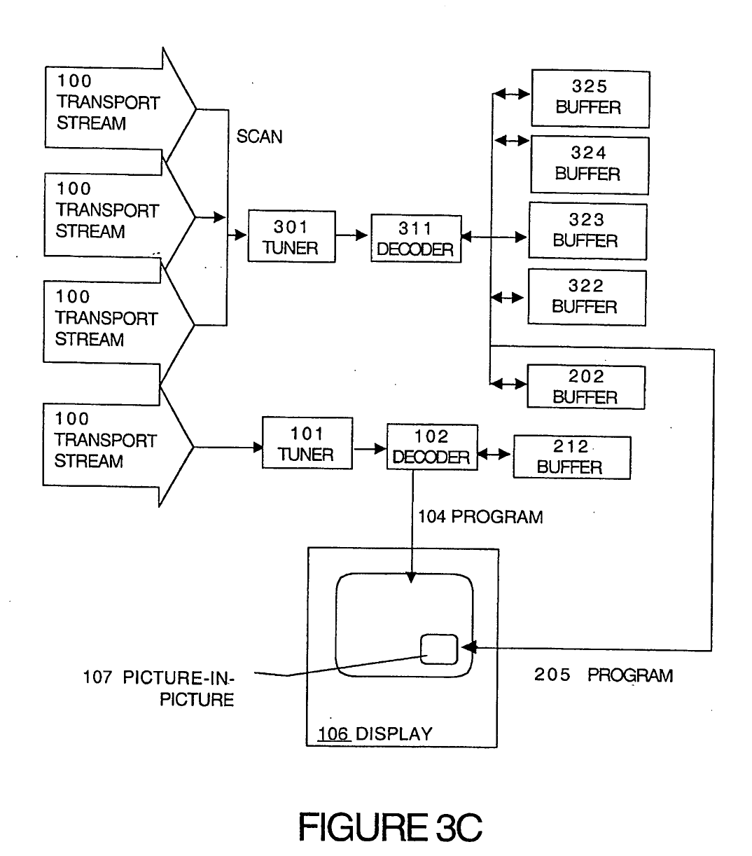

FIG. 3A illustrates a process 300 for rapid digital television channel change using a spare tuners/decoders in accordance with an embodiment of the present invention for tuning/decoding digital content from channels which are predicted to be next viewed. In this case, if a spare tuner is tuned to a predicted channel and that predicted channel happens to be the next channel to be watched, then the spare tuner and the main tuner can “swap” roles thereby providing a fast channel change experience.

There are many system configurations which provide spare tuners. In some applications, the PIP tuner can be spare when not performing PIP functionality. In other high-end systems, several “spare” tuners can be provided in addition to the PIP tuner. In the example of FIG. 3A, a first tuner is used, a second tuner for PIP is used and a third tuner is also available within the system.

In FIG. 3A, a first digital television transport stream, associated with a first RF frequency, is accessed using a first tuner at step 310. At 320, a first program associated with the first digital transport stream is displayed in the main display area of a television system. At 330, a second tuner is used to access a second transport stream in a second RF frequency or some other second source. In one embodiment, this tuner may be dedicated for PiP services.

At 335, the digital content from a predicted next program channel in the second transport stream may be decoded. In this embodiment, the PiP tuner may be optional.

At step 340, a third tuner is used to access a third transport stream regarding a predicted next channel. The third transport stream can be carried in a third RF frequency, as illustrated. The third transport stream can also be carried in a cable carrier or can be from a media player such as a DVD player or a VCR. The digital content for the third tuner is decoded at 350. The decoded content from the second and third tuners is not displayed at this point.

If, at 355, a change to a new program channel is desired, and at 356 if digital content is already being decoded for that new channel (e.g., one of the other tuners has accurately predicted this new channel), then the digital content is obtained from the relevant tuner/decoder at 360 in order to enable rapid decoding of the program channel content stream. The selected tuner is then used to rapidly display image information onto the main display area of the television system. (For the sake of discussion, assume that the second tuner was the one decoding the newly selected channel.)

At step 370, the roles are swapped between the first tuner and the tuner that was properly decoding the newly selected channel (e.g., the second tuner). On the other hand, if the new channel selected is related to the third tuner, then the roles of the first tuner and the third tuner can swap at step 370 thereby implementing the fast channel change operation.

At 380, when the change to a new channel is effected, the first tuner becomes available to access another program channel (according to the example described above). This fourth program channel can be in a transport stream carried in a different RF frequency or a non-radiated medium or any other medium suitable for delivery of a transport stream.

However, if, at step 356, the requisite channel program information is not properly predicted (e.g., none of the spare tuners predicted this new channel), the transport stream containing the desired program channel is accessed at step 357 using the first tuner. The information is acquired and decoding can commence as necessary using the first tuner and decoder.

The system described above can also include a fourth (or more) tuner(s). In this case, the third and fourth tuners can be used for tuning different predicted channels and the channels can be independently predicted. If the next channel to be displayed was accurately predicted by the fourth tuner, then the fourth tuner and the first tuner can swap roles. Alternatively, the third tuner can be used for predicting a next PIP channel while the fourth tuner is used for predicting the next main display channel.

Another embodiment relates to a combination which occurs when both pictures that are on the screen are in the same transport stream (TS); that is they can be received with a single tuner/demodulator. In this case, the first tuner can tune this TS, and depending on how may tuner/demodulators are in the system, the second (PIP) tuner and third tuner and even a fourth tuner could be used to predict the next channel for the main display (e.g., the first tuner), thereby greatly increasing the chance that the next channel selected would be able to be changed to rapidly and seamlessly.

Another implementation of fast channel change is accomplished when the user is watching programs on separate transport streams using the first and second tuners and the channel selected to replace the first tuner is within the transport stream of the second tuner. Then the fast channel change can occur and the first tuner can be used to predict the next desired channel. It is appreciated that this embodiment works even in two tuner systems.

FIG. 3B illustrates a system for rapid digital television channel change in a picture-in-picture receiver in which a plurality of tuners and decoders are used to scan and decode a plurality of transport streams in order to predict a next channel in accordance with an embodiment of the present invention.

Transport streams 100 carry program channels. The program channels may be multiplexed in a single transport stream or in a plurality of streams.

Tuner 101 accesses a first transport stream. It is noted that tuner 101, as other tuners, may include a demultiplexing device or a PID filter in order to separate out a specific program channel. A demultiplexing device or a PID filter may also be implemented in some other fashion.

Decoder 102 decodes the program content from the selected program channel and presents the content, in the form of main program 104, to the display 106.

Tuner 201 is shown, in FIG. 3B, accessing a transport stream which contains a second program channel. Again, the second program channel can be in the same transport stream as other selected program channels or in a different stream. The second program channel can also, in a case such as that where a user is viewing both broadcast and recorded programming, be from a source such as a DVD or video cassette player, for example.

Decoder 103 receives the content stream from tuner 201 and either decodes the content for presentation as program 205 to a picture-in-picture display 107 or, if the picture-in-picture display is not being used, can continue to decode the program information from the second program channel. Therefore, when the video decoder is not being used for PiP, it can be decoding a predicted channel. The decoder is continuously decoding the program, the decoded program is just not being displayed. If the user selects that program next, the switch to that program can be instantaneous because it is already available.

Tuner 301 and decoder 311 access a third transport stream and decode a third program channel whose digital content (e.g., I-frames, table information, etc.) is cached in buffer 322. The digital content cached in buffer 322 is available for rapid decoding of the third program channel if the third program channel is selected for viewing, thus reducing the time required to present the newly selected channel. As discussed previously, prediction of the next channel to be selected for viewing increases the likelihood that the program channel currently being decoded but not displayed is the one to be selected by the user. When selected, decoder 311 presents rapidly decoded program content to either main display 106 or picture-in-picture display 107.

One embodiment of the present invention is also implemented with a fourth tuner 302 and a fourth decoder 312. Tuner 302 and decoder 312 can access and decode a fourth program channel or can cache its digital content in buffer 323 for subsequent decoding and presentation.

FIG. 3C illustrates an embodiment of the present invention in which a second tuner and decoder are used to scan and decode channels of a plurality of transport streams in order to cache multiple digital content (e.g., I-frames, table information, etc.) to help predict a next channel in accordance with an embodiment of the present invention. While tuner 101 and decoder 102 are decoding and presenting program 104 to display 106, tuner 301 and decoder 311 scan transport streams carrying predicted program channels. With the acquisition of new digital content for a program channel, the information is stored in a buffer, 322-325.

In one embodiment of the present invention, buffers 322-325 can be implemented in a single device as an array of stored tables. Each stored table in such an implementation can store all the information required to access and decode each associated program channel.

As discussed above, when a channel change is desired, the information including the relevant digital content associated with the selected program channel is obtained directly from the relevant tuner/decoder. recalled from the applicable buffer and decoding can commence quickly.

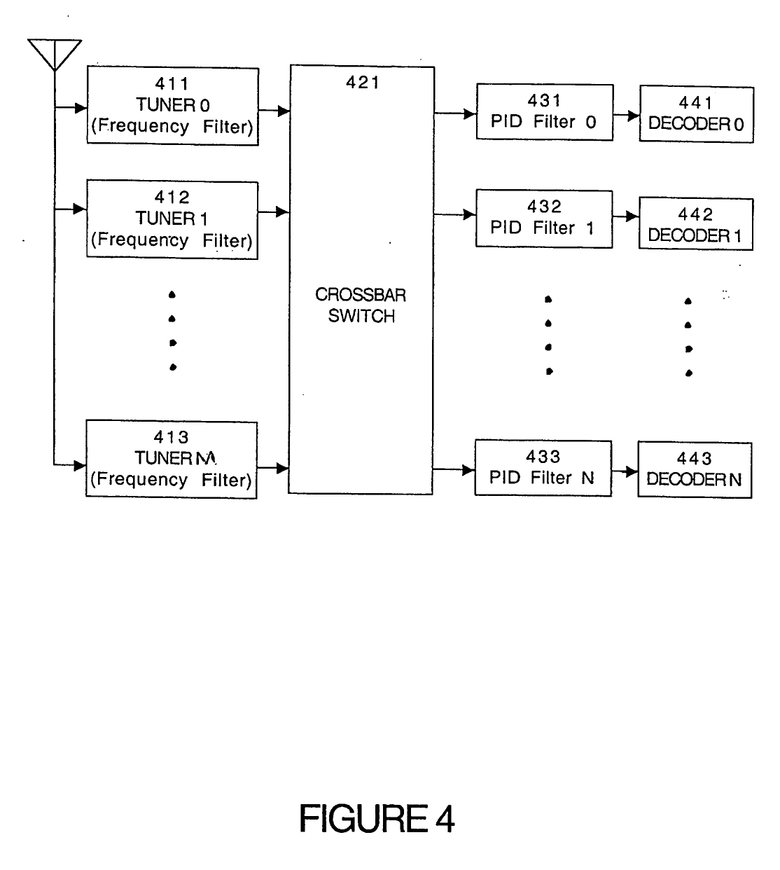

FIG. 4 illustrates an embodiment of a switched universal system by which multiple tuners can tune to different transport streams and can supply the program stream to different decoders. Multiple tuners (M) can be used to supply information to multiple decoders (N) for displaying on a main screen and one or more picture-in-picture regions, for instance. In this example, up to M channels can be tuned while supporting as many as N display screens, or N−1 predicted channels.

Here, tuner 0, 411, tuner 1, 412 through tuner N, 413, are shown accessing an RF source. In this illustration, the RF source is capable of supplying a plurality of RF frequencies to the tuners. The outputs of the tuners are fed to PID filters and associated decoders via crossbar switch 421.

Crossbar switch 421 is enabled to switch any of the output transport streams of the tuners to any of the inputs of decoders via PID (program identifier) filters. Each PID filter separates out (filters) to select a specific program channel from the transport stream it receives. This is one implementation of a method used to demultiplex a transport stream carrying a plurality of program channels to access a particular program channel.

The outputs of PID filter 0, 431, PID filter 1, 432, and PID filter N, 433, feed to associated decoder 0, 441, decoder 1, 442 and decoder N, 443, respectively. The outputs of the decoders, which are decoded program content streams or decoded and storable program information, are then able to either be presented to a display or to be stored, as appropriate. The crossbar switch system, it is noted, can be implemented in any system in which a tuner output requires the capability of outputting to different decoders. If some of the tuners, and/or decoders are speculatively used to continuously decode programs that may be requested next by a user, then any of those programs can be instantly switched to when selected.

### Fast Channel Change Using a Spare Decoder

It is noted that, currently, a single piece of hardware implementing an MPEG decoder may run much faster than is needed for one MPEG stream. These MPEG decoders are often designed to decode more than one transport stream. This implements multiple virtual MPEG decoders in a single piece of hardware. Further, it is possible for systems to provide hardware-based dedicated “spare” decoders. Techniques illustrated in embodiments of the present invention can use this kind of virtual MPEG decoder, or dedicated decoder, where the surplus bandwidth of the decoder becomes one or more “unused” decoders.

When a channel change is desired by the user in this embodiment, providing that one of the predicted channels is the one to be viewed next, the new channel is already being decoded, current video is already available, and can be switched to instantaneously.

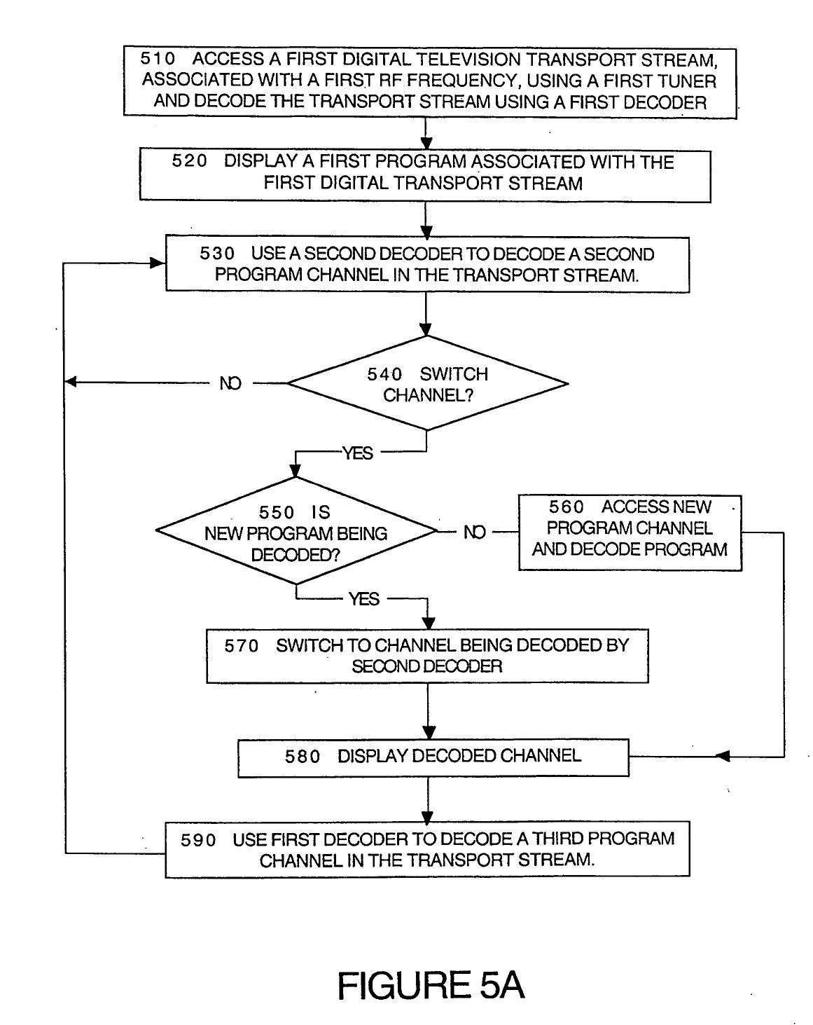

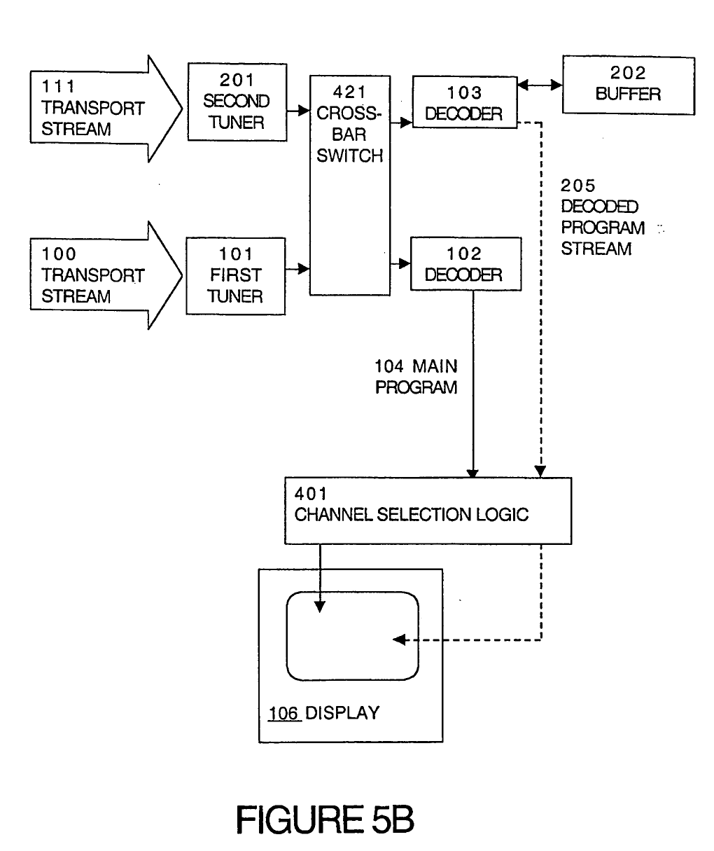

FIG. 5A illustrates a method for fast digital television channel change using a second decoder to predictively decode a program channel in accordance with an embodiment of the present invention. Again, as before, a first digital television transport stream, associated with a first RF frequency is accessed using a first decoder 510.

At 520, a program channel, which has been decoded as discussed previously and which is associated with the first transport stream, is displayed in a main display area of the television receiver.

At 530, a second program channel is decoded using a second decoder, and can be continually decoded in the background. The second program channel can be associated with a second RF frequency or can be from the same RF frequency as the first program channel. It is noted that the second channel to be decoded can be selected by any of the predictive means discussed previously.

If the user elects to change the viewed channel at 540, and the selected channel is the one being decoded by the second decoder, 550, the switch is effected at 570. This results in an immediate, seamless, change to the program channel which is already being decoded. The effect is the desirable apparently instantaneous channel change.

If the second program channel being decoded is not the channel selected by the user, then the selected channel is accessed and decoded at 560. The predictive processes discussed previously can reduce the likelihood that the selected channel will not be the channel being decoded in the background.

When the channel change has been effected, the first decoder can be used to access and decode the next predicted program channel. The first decoder then continues to decode the next predicted channel until the channel is selected for display or another channel is predicted as the likely next selected channel.

FIG. 5B illustrates a system for fast digital television channel change using a second or spare decoder to predictively decode a program channel in accordance with an embodiment of the present invention. Here tuners 101 and 201 access transport streams 100 and 111, respectively. Both tuners illustrated in FIG. 5B are connected to decoders 102 and 103 in this embodiment by crossbar switch 421.

Transport stream 100 contains the program channel that is decoded by decoder 103 to become main program 104. Decoded program 104 is presented to display 106 as the main, or currently viewed, program.

Transport stream 111 contains the program channel which is decoded by decoder 103. The decoded program channel becomes program stream 205. When program 205 is not being viewed, it is not presented to a display. When program stream 205 is selected by channel selection logic as indicated at 401, program stream 205 becomes the main, or viewed, program.

When the newly selected program, 205, is presented to the display 106, program 104 is either discarded or continued to be decoded if it is the predicted next channel to be selected. Program 104 would be the predicted channel if, for example, the user is alternating back and forth between program 104 and program 205. Any of the previously discussed predictive methods can be used to predict the next channel to be selected.

When there is no next program channel predicted, or if there is more than one channel predicted, decoder 103 can store program information from another channel in buffer 202. In the implementation shown, the program information from a third channel can be stored in buffer 202 while the second channel is being decoded for possible selection by the user. This implementation can be employed when one predicted channel has a higher probability of next selection than another which is also a predicted channel.

It is noted here that, in another embodiment, there are multiple storage buffers implemented. This enables the system to predict a plurality of program channels and store decoded program specific digital content from each of them. In this way, in this other embodiment, there is a higher probability that the selected new channel will be one from which there is decoded and stored recent program specific digital content.

Regarding FIG. 5B, if the channel being watched (first channel) and a predicted next channel (second channel) share the same transport stream, then the first decoder 102 and the second decoder 103 can operate using the same tuner 101 and, in this case, the second tuner 201 would not be required to provide fast channel change between the first and second channels.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for displaying digital content comprising:
using a first tuner to access a first transport stream associated with a first frequency;
displaying in a main picture area of a display screen, a program associated with said first transport stream;
using a second tuner during spare periods to access a second transport stream associated with a second frequency;
decoding digital content from said second transport stream and caching said digital content into a memory buffer; and
upon said first tuner being switched to a new channel associated with said program information stored in said memory buffer, recalling said digital content for use in providing a fast channel change operation to said new channel.

2. A method as described in claim 1 wherein said second tuner is normally dedicated to picture-in-picture rendering on said display screen.

3. A method as described in claim 2 wherein said digital content comprises table information associated with said second transport stream.

4. A method as described in claim 3 wherein said table information is derived from a program association table that is encoded in said second transport stream.

5. A method as described in claim 2 wherein said digital content comprises decoded I frames of said new channel.

6. A method as described in claim 2 further comprising:
using said second tuner to scan through a plurality of frequencies over time to access a plurality of transport streams;
decoding digital content from said plurality of transport streams; and
caching said digital content decoded from said plurality of transport streams in said memory buffer.

7. A method as described in claim 1 wherein said first transport stream and said second transport stream are the same and wherein said first frequency and said second frequency are the same.

8. A method as described in claim 2 wherein said digital content cached to said memory buffer is associated with a channel that is a predicted next channel which is predicted based on previous channel selections.

9. A method for displaying digital content comprising:
using a first tuner to access a first transport stream associated with a first frequency;
displaying in a main picture area of a display screen, a program associated with said first transport stream;
using a second tuner to access a second transport stream associated with a second frequency;
decoding first digital content from said second transport stream and caching said first digital content into a memory buffer;
using a third tuner to access a third transport stream associated with a third frequency;
decoding second digital content from said third transport stream and caching said second digital content into said memory buffer; and
upon a channel change to a new channel associated with said second or third tuner, recalling digital content from said memory buffer for use in providing a fast channel change operation to said new channel.

10. The method of claim 9 wherein said second tuner is normally dedicated for picture-in-picture rendering on said display screen.

11. A method as described in claim 9 wherein in response to a channel change to said third tuner, performing the following:
using said third tuner to access said third transport stream;
displaying in said main picture area of said display screen, said new channel associated with said third transport stream;
using said first tuner to access a fourth transport stream associated with a fourth frequency; and
decoding digital content from said fourth transport stream and caching said digital content into said memory buffer.

12. A method as described in claim 9 wherein said digital content comprises decoded I-frames of said new channel.

13. A method as described in claim 12 wherein said digital content further comprises table information associated with said third transport stream.

14. A method as described in claim 9 further comprising:
using said third tuner to scan through a plurality of frequencies over time to access a plurality of transport streams;
decoding digital content from said plurality of transport streams; and
caching said digital content decoded from said plurality of transport streams to said memory buffer.

15. A method as described in claim 9 wherein said second digital content cached to said memory buffer is associated with a channel that is a predicted next channel which is predicted based on previous channel selections.

16. A method as described in claim 15 wherein said first digital content cached to said memory buffer is associated with another channel that is a predicted next channel which is predicted based on previous channel selections.

17. A method for displaying digital content comprising:
using a first tuner to access a first transport stream associated with a first frequency;
displaying in a main picture area of a display screen, a program associated with said first transport stream;
using a second tuner to access a second transport stream associated with a second frequency;
decoding table information from said second transport stream and caching said table information into a memory buffer, said table information comprising program identifications for programs of said second transport stream; and
upon a channel change to a new channel associated with said second transport stream, recalling said table information for use in providing a fast channel change operation to said new channel.

18. A method as described in claim 17 further comprising:
decoding I-frames associated with programs of said second transport stream; and
caching said I-frames to said memory buffer; and
upon said channel change to said new channel, also recalling cached I-frames for use in providing said fast channel change operation to said new channel.

19. A method as described in claim 17 wherein said second tuner is normally dedicated to picture-in-picture rendering on said display screen.

20. A method as described in claim 17 further comprising:
using said second tuner to also scan through a plurality of frequencies over time to access a plurality of transport streams; and
decoding and caching a plurality of table informations from said plurality of transport streams to said memory buffer.

21. A method as described in claim 17 wherein said new channel is a predicted next channel predicted based on prior channel selections.

22. A method as described in claim 17 wherein said first transport stream and said second transport stream are the same.

23. A method for displaying digital content comprising:
using a first tuner and a first decoder to access and decode a first transport stream associated with a first frequency;
displaying in a main picture area of a display screen, a program associated with said first transport stream;
using a second decoder to decode a second program;
upon a channel change to a new channel associated with said second program, using said second decoder to display in said main picture area of said display screen said second program to provide a fast channel operation to said new channel.

24. A method as described in claim 23 wherein said first transport stream comprises said second program.

25. A method as described in claim 23 wherein said second decoder is a spare decoder and wherein said second program is a predicted next program.

26. A method as described in claim 23 wherein said second program is associated with a second transport steam and further comprising: using a second tuner to access said second transport stream.

27. A method as described in claim 23 further comprising:
using a second tuner and a third decoder to access and decode a second transport stream associated with a second frequency; and
displaying in a picture-in-picture area of a display screen, a program associated with said second transport stream.

28. A method as described in claim 26 further comprising:
using a third tuner and a third decoder to access and decode a third transport stream associated with a third frequency; and
displaying in a picture-in-picture area of a display screen, a program associated with said third transport stream.

29. A method as described in claim 26 wherein said second program is a predicted next program further comprising:
using a third tuner and a third decoder to access and decode a third program wherein said third program is a predicted next program.
